(19) United States
(12) Patent Application Publication
(10) Pub. No.: US 2026/0012866 A1
(43) Pub. Date: Jan. 8, 2026

(54) AP SIDE HYSTERESIS RECOMMENDATION SETUP FOR ROAMING

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/228,615

(22) Filed: Jun. 4, 2025

Related U.S. Application Data
(60) Provisional application No. 63/667,494, filed on Jul. 3, 2024.
(60) Provisional application No. 63/667,502, filed on Jul. 3, 2024.
(60) Provisional application No. 63/668,072, filed on Jul. 5, 2024.
(60) Provisional application No. 63/668,084, filed on Jul. 5, 2024.
(60) Provisional application No. 63/671,657, filed on Jul. 15, 2024.

(51) Int. Cl. H04W 36/08; H04W 36/16; H04W 36/30

(52) U.S. Cl. CPC H04W 36/08; H04W 36/16; H04W 36/302

(57) ABSTRACT

Methods and apparatuses for AP side hysteresis recommendation setup for roaming in next generation WLANs. A method performed by a station (STA) includes determining to roam from a first access point (AP) to a second AP, and performing a procedure to reduce roaming of the STA between the first AP and the second AP.

### CROSS-REFERENCE TO RELATED APPLICATION(S) AND CLAIM OF PRIORITY

This application claims priority under 35 U.S.C. § 119(e) to U.S. Provisional Patent Application No. 63/667,494, filed on Jul. 3, 2024, U.S. Provisional Patent Application No. 63/667,502, filed on Jul. 3, 2024, U.S. Provisional Patent Application No. 63/668,072, filed on Jul. 5, 2024, U.S. Provisional Patent Application No. 63/668,084, filed on Jul. 5, 2024, and U.S. Provisional Patent Application No. 63/671,657, filed on Jul. 15, 2024, each of which is hereby incorporated by reference in its entirety.

### TECHNICAL FIELD

This disclosure relates generally to wireless communication, and more specifically to access point (AP) side hysteresis recommendation setup for roaming in next generation Wireless Local Area Networks (WLANs).

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for AP side hysteresis recommendation setup for roaming in next generation WLANs.

In one embodiment, a method performed by a station (STA) includes determining to roam from a first access point (AP) to a second AP; and performing a procedure to reduce roaming of the STA between the first AP and the second AP.

In another embodiment, a first AP comprises a transceiver, and a processor operably coupled with the transceiver. The processor is configured to: generate a message associated with a STA that has determined to roam from the first AP to a second AP. The message includes information associated with a procedure to reduce roaming of the STA between the first AP and the second AP. The processor is further configured to transmit, via the transceiver, the message to the STA.

In yet another embodiment, a STA comprises a transceiver, and a processor operably coupled with the transceiver. The processor is configured to: determine to roam from a first AP to a second AP, and perform a procedure to reduce roaming of the STA between the first AP and the second AP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit”, “receive”, and “communicate”, as well as derivatives thereof, encompass both direct and indirect communication. The terms “include” and “comprise”, as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example AP according to embodiments of the present disclosure;

FIG. 3 illustrates an example STA according to embodiments of the present disclosure;

FIG. 4 illustrates an example of stages involved during a mobility handover procedure according to embodiments of the present disclosure;

FIG. 5 illustrates an example of received signal strength indicator (RSSI) fluctuation according to embodiments of the present disclosure;

FIG. 6 illustrates an example operation of hysteresis recommendation according to embodiments of the present disclosure;

FIG. 7 illustrates an example roam pause operation according to embodiments of the present disclosure;

FIG. 8 illustrates an example of a message that can contain an indication of criteria that the STA can use according to embodiments of the present disclosure;

FIG. 9 illustrates an example of a message for threshold indication according to embodiments of the present disclosure;

FIG. 10 illustrates an example operation of a capability indication according to embodiments of the present disclosure;

FIG. 11 illustrates an example operation by embedding signaling in a link switch procedure according to embodiments of the present disclosure;

FIG. 12 illustrates an example operation indicating that ping pongs have occurred in the past between AP1 and AP2 according to embodiments of the present disclosure;

FIG. 13 illustrates another example operation indicating that ping pongs have occurred in the past between AP1 and AP2 according to embodiments of the present disclosure;

FIG. 14 illustrates an example operation for a ping pong warning message according to embodiments of the present disclosure;

FIG. 15 illustrates another example operation for a ping pong warning message according to embodiments of the present disclosure;

FIG. 16 illustrates an example operation for setup of a ping pong warning message according to embodiments of the present disclosure; and

FIG. 17 illustrates an example method performed by a STA in a wireless communication system according to embodiments of the present disclosure.

### DETAILED DESCRIPTION

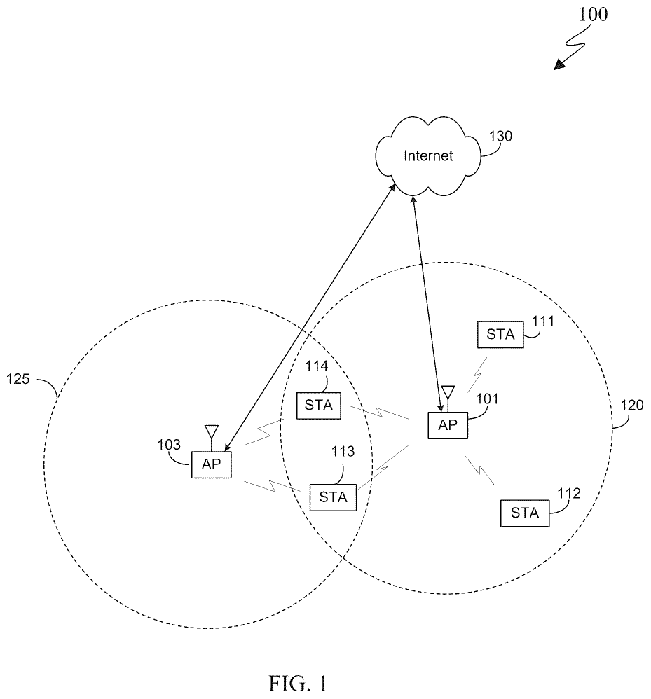

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1] IEEE P802.11be/D3.0, 2023; [2] IEEE Std 802.11-2020.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP”, such as “router” or “gateway”. For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA”, such as “mobile station”, “subscriber station”, “remote terminal”, “user equipment”, “wireless terminal”, or “user device”. For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the APs may include circuitry and/or programming for facilitating AP side hysteresis recommendation setup for roaming in next generation WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

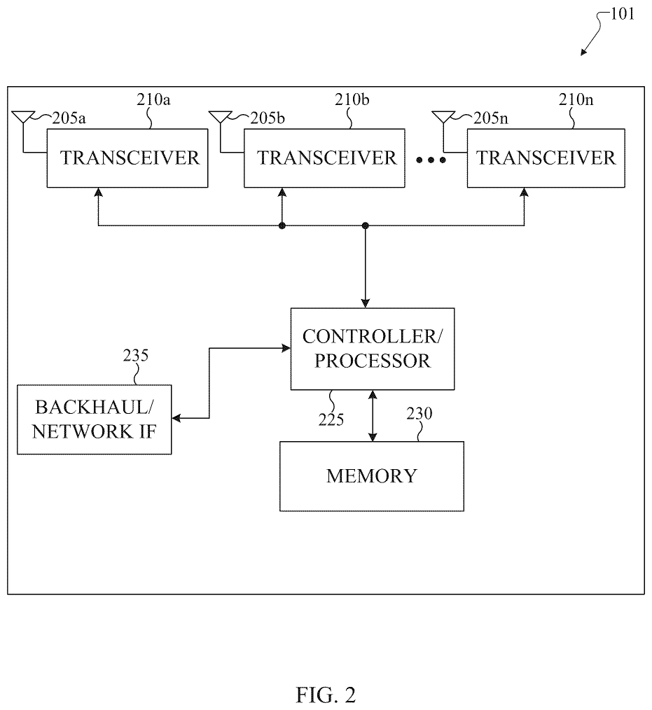

FIG. 2 illustrates an example AP 101 according to various embodiments of the present disclosure. The embodiment of the AP 101 illustrated in FIG. 2 is for illustration only, and the AP 103 of FIG. 1 could have the same or similar configuration. However, APs come in a wide variety of configurations, and FIG. 2 does not limit the scope of this disclosure to any particular implementation of an AP.

The AP 101 includes multiple antennas 205a-205n and multiple transceivers 210a-210n. The AP 101 also includes a controller/processor 225, a memory 230, and a backhaul or network interface 235. The transceivers 210a-210n receive, from the antennas 205a-205n, incoming radio frequency (RF) signals, such as signals transmitted by STAs 111-114 in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the AP 101. For example, the controller/processor 225 could control the reception of forward channel signals and the transmission of reverse channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing signals from multiple antennas 205a-205n are weighted differently to effectively steer the outgoing signals in a desired direction. The controller/processor 225 could also support OFDMA operations in which outgoing signals are assigned to different subsets of subcarriers for different recipients (e.g., different STAs 111-114). Any of a wide variety of other functions could be supported in the AP 101 by the controller/processor 225 including facilitating AP side hysteresis recommendation setup for roaming in next generation WLANs. In some embodiments, the controller/processor 225 includes at least one microprocessor or microcontroller. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the AP 101 to communicate with other devices or systems over a backhaul connection or over a network. The interface 235 could support communications over any suitable wired or wireless connection(s). For example, the interface 235 could allow the AP 101 to communicate over a wired or wireless local area network or over a wired or wireless connection to a larger network (such as the Internet). The interface 235 includes any suitable structure supporting communications over a wired or wireless connection, such as an Ethernet or RF transceiver. The memory 230 is coupled to the controller/processor 225. Part of the memory 230 could include a RAM, and another part of the memory 230 could include a Flash memory or other ROM.

As described in more detail below, the AP 101 may include circuitry and/or programming for facilitating AP side hysteresis recommendation setup for roaming in next generation WLANs. Although FIG. 2 illustrates one example of AP 101, various changes may be made to FIG. 2. For example, the AP 101 could include any number of each component shown in FIG. 2. As a particular example, an access point could include a number of interfaces 235, and the controller/processor 225 could support routing functions to route data between different network addresses. Alternatively, only one antenna and transceiver path may be included, such as in legacy APs. Also, various components in FIG. 2 could be combined, further subdivided, or omitted and additional components could be added according to particular needs.

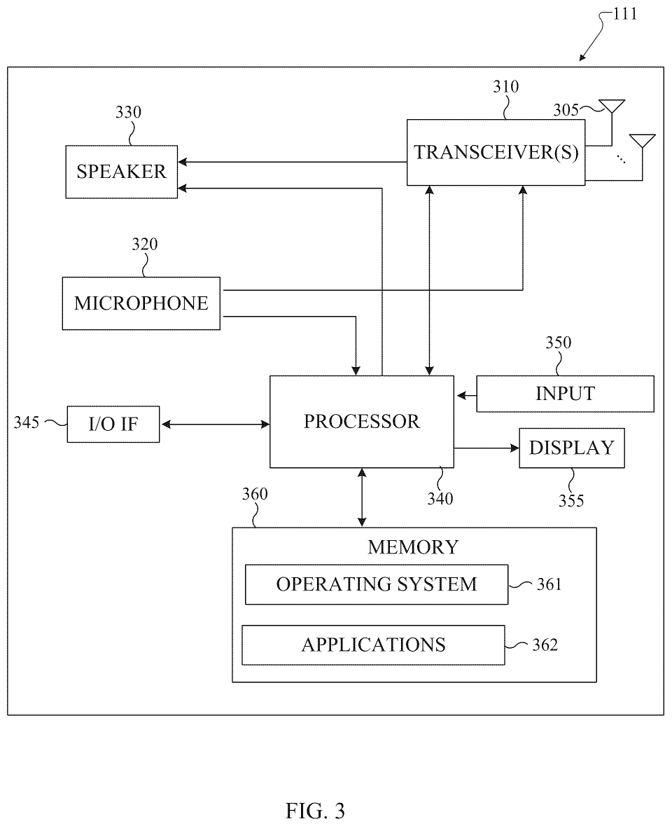

FIG. 3 illustrates an example STA 111 according to various embodiments of the present disclosure. The embodiment of the STA 111 illustrated in FIG. 3 is for illustration only, and the STAs 111-114 of FIG. 1 could have the same or similar configuration. However, STAs come in a wide variety of configurations, and FIG. 3 does not limit the scope of this disclosure to any particular implementation of a STA.

The STA 111 includes antenna(s) 305, transceiver(s) 310, a microphone 320, a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna(s) 305, an incoming RF signal (e.g., transmitted by an AP 101 of the network 100). The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors and execute the basic OS program 361 stored in the memory 360 in order to control the overall operation of the STA 111. In one such operation, the processor 340 controls the reception of forward channel signals and the transmission of reverse channel signals by the transceiver(s) 310 in accordance with well-known principles. The processor 340 can also include processing circuitry configured to facilitate AP side hysteresis recommendation setup for roaming in next generation WLANs. In some embodiments, the processor 340 includes at least one microprocessor or microcontroller.

The processor 340 is also capable of executing other processes and programs resident in the memory 360, such as operations for facilitating AP side hysteresis recommendation setup for roaming in next generation WLANs. The processor 340 can move data into or out of the memory 360 as required by an executing process. In some embodiments, the processor 340 is configured to execute a plurality of applications 362, such as applications for facilitating AP side hysteresis recommendation setup for roaming in next generation WLANs. The processor 340 can operate the plurality of applications 362 based on the OS program 361 or in response to a signal received from an AP. The processor 340 is also coupled to the I/O interface 345, which provides STA 111 with the ability to connect to other devices such as laptop computers and handheld computers. The I/O interface 345 is the communication path between these accessories and the processor 340.

The processor 340 is also coupled to the input 350, which includes for example, a touchscreen, keypad, etc., and the display 355. The operator of the STA 111 can use the input 350 to enter data into the STA 111. The display 355 may be a liquid crystal display, light emitting diode display, or other display capable of rendering text and/or at least limited graphics, such as from web sites. The memory 360 is coupled to the processor 340. Part of the memory 360 could include a random-access memory (RAM), and another part of the memory 360 could include a Flash memory or other read-only memory (ROM).

Although FIG. 3 illustrates one example of STA 111, various changes may be made to FIG. 3. For example, various components in FIG. 3 could be combined, further subdivided, or omitted and additional components could be added according to particular needs. In particular examples, the STA 111 may include any number of antenna(s) 305 for MIMO communication with an AP 101. In another example, the STA 111 may not include voice communication or the processor 340 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

Embodiments of the present disclosure recognize that as users move around, the signal strength of a station (STA) to its connected access point (AP) can vary. If user movement causes a significant decrease in the signal strength, a handover is necessary. During the process of handover, the STA switches from its current associated AP to a new AP.

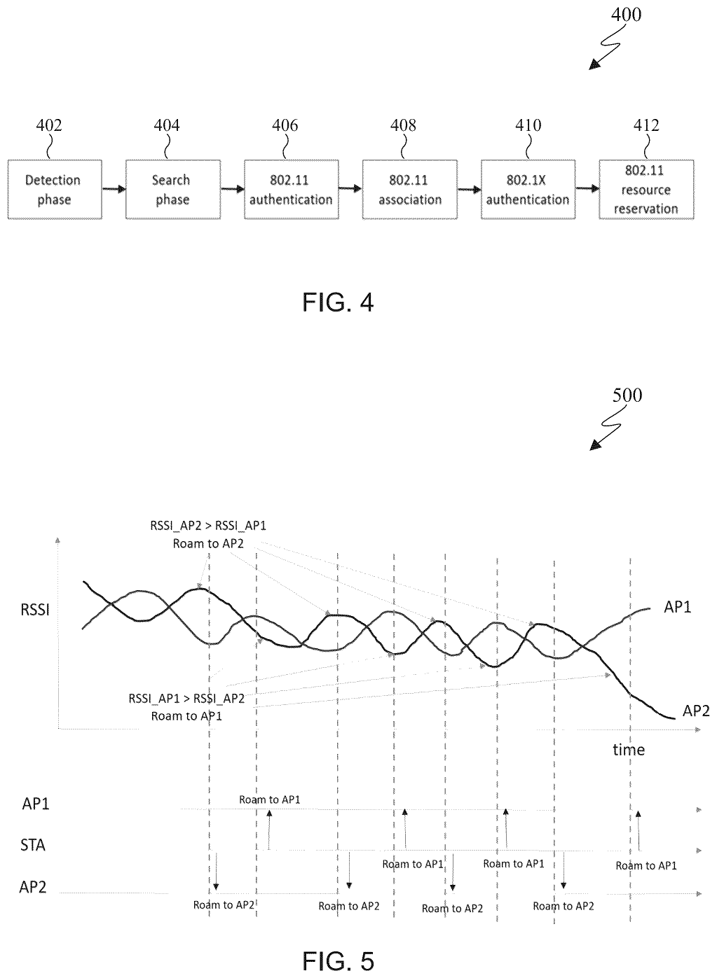

FIG. 4 illustrates an example of stages involved during a mobility handover procedure 400 according to embodiments of the present disclosure. For example, the mobility handover procedure 400 can be performed by any of the STAs 111-114, any of the APs 101, 103, and/or the network 130 of FIG. 1. The embodiment of the example of stages involved during a mobility handover procedure 400 shown in FIG. 4 is for illustration only. Other embodiments of the example of stages involved during a mobility handover procedure 400 could be used without departing from the scope of this disclosure.

As shown in FIG. 4, in legacy devices without any mobility support, the handover procedure involves the following steps:

1. Detection phase: during the detection phase 402, the STA determines that there is a need for a handover, and is typically left to vendor implementation. For example, a particular vendor implementation can choose to trigger handover when the signal strength to the currently associated AP drops below a certain threshold.

2. Search phase: the detection phase 402 is followed by a search phase 404. During the search phase 404, the STA searches for new APs to associate with. During the search phase 404, the STA performs a scan of different channels to identify APs in the vicinity. This can be done either passively (e.g., listening to beacons on a particular channel) or actively (e.g., by the use of probe request and response procedures). Passive scan can take a lot of time as the scanning STA needs to wait on each channel for a sufficient amount of time to ensure that the beacon is received from APs on that channel. Since each AP transmits beacons after a certain period of time (e.g., 100 ms), passive scan can consume a lot of time. In the case of active scan, the STA transmits a probe request and waits for a probe response from APs in the vicinity. Without prior knowledge of APs in the vicinity, active scan can take several seconds to complete.

3. 802.11 authentication: after the scanning procedure is complete, the next step is to perform 802.11 authentication 406 (open system/shared key based)), where the STA establishes its identity with the AP.

4. 802.11 association: Once the STA is authenticated, the next step is to perform association 408.

5. 802.1X authentication: Introduced in IEEE 802.11 amendment, the 802.1X authentication phase 410 comprises an EAP authentication between the STA and a AAA server with the assistance of the AP.

6. 802.11 resource reservation: Finally, in the 802.11 resource reservation phase 812, the STA sets up various resources at the new AP. For example, the STA can perform QoS reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures is to remove/reduce the delay encountered in various steps of the handover procedure. In 2008, IEEE 802.11r introduced a fast transition roaming which eliminates the need for the authentication step 406 (step 3 above) during the handover. In 2011, IEEE 802.11k introduced assisted roaming which reduces the search phase 404 (step 2 above) by allowing the STA to request the AP to send channel information of candidate neighbor APs. In 2011, IEEE 802.11v also introduced network assisted roaming to assist the search phase 404. Thus, with a combination of IEEE 802.11v and IEEE 802.11k support, the search time can be reduced by enabling the device to scan only those channels on which APs in the vicinity operate. In IEEE 802.11be, the fast BSS transition procedure was extended to cover the case of MLO operation. This procedure helps to reduce the delays encountered due to 802.11 resource reservation 412 (step 6 above).

FIG. 5 illustrates an example of RSSI fluctuation 500 according to embodiments of the present disclosure. The embodiment of the example of RSSI fluctuation 500 shown in FIG. 5 is for illustration only. Other embodiments of the example of RSSI fluctuation 500 could be used without departing from the scope of this disclosure.

Embodiments of the present disclosure recognize that when a STA roams from one AP to another, the parameter that the STA can use to determine a need to roam can fluctuate over time. This can cause the STA to trigger roam multiple times over a short period of time. An example can be as follows. Consider a STA that is associated with AP1 and uses RSSI as a parameter to determine the need to roam. The STA can hear another AP (for example AP2) that has an RSSI that is higher than the RSSI of AP1 and can trigger a roam to AP2. However, since RSSI is a parameter that can fluctuate over a short period of time, AP2's RSSI can also reduce and go below AP1's RSSI triggering the STA to roam to AP 1. Such fluctuations can cause the STA to vacillate between two APs when it would have been better to not roam at all. An example of RSSI fluctuation can be as shown in FIG. 5. The same issue can occur with other roaming parameters such as load, error rate, etc., possibly on a longer time scale. A procedure to reduce the number of roams that get triggered in such a scenario can be useful. A procedure to pause roaming during such periods can be useful.

Embodiments of the present disclosure recognize that a STA can make a link switch request multiple times over a short period of time. However, handling such multiple link switch recommendations may not be efficient from the AP point of view as the processing can delay other operations. Further, as the number of such STAs making such requests increases over a long period of time, the network side load of processing such operations can cause some delays to other critical operations. Thus, the AP/logical entity may need to pause/suspend link switch to minimize the load. Procedures by which the AP/logical entity can pause/suspend link switch requests can be beneficial.

Embodiments of the present disclosure recognize that as the STA performs link reconfiguration, it is important that the application running on the STA does not suffer a deterioration. Therefore, it is important that the STA can determine beforehand if it is transitioning to an AP where the application will not suffer any deterioration. To achieve this, the STA may need to know—

1. The appropriate switching criteria. For example, if the STA is in a domain of APs where the RSSI to APs may not differ from AP to AP. The STA may end up not switching at all as the RSSI is more or less the same/the STA may switch to an AP that has better RSSI but worse load. Knowledge of which parameters to give higher weightage when making a link switch can be important.

2. Thresholds for switching parameters. For example, the STA may be using incorrect thresholds for switching parameters which can cause the STA to make decisions either too late or too early. Thus, knowledge of the values that the STA should use as thresholds for making a switching decision can be important.

The AP may have better knowledge of the parameters and their corresponding thresholds. However, a procedure by which the AP can make a recommendation to the STA can be beneficial.

Embodiments of the present disclosure recognize that one of the problems encountered in baseline roaming procedures is ping pong. In this problem, a STA can roam from one AP to another AP after observing a higher signal strength from the second AP. However, as the signal strength of the second AP degrades, the device can return to the first AP. This can go on in a loop as both APs' signal strength fluctuates and the device can go into a ping pong loop wherein it first roams to the second AP and then after some time roams to the first AP and again roams to the second AP with fluctuations in signal strength. This can cause continuous disruption to the applications running on the STA without any gain to it.

Ping pong can be detected after it occurs. For example, if a STA is stuck in a ping pong loop, the STA can detect ping pong after several roams have occurred. Similarly, the APs involved can detect a ping pong effect. However, the STA's applications would have suffered by the time the ping pong problem is detected and stopped.

A procedure to stop the ping pong problem early on can be beneficial. The procedure needs to consider averting ping pong from occurring or stop it in a very early phase, for example in the first few roams.

Accordingly, embodiments of the present disclosure provide mechanisms for an AP side hysteresis recommendation, including: 1. a hysteresis value recommendation procedure; 2. a request and response based setup; 3. a setup during association; 4. an unsolicited indication/recommendation procedure; and 5. a capability indication.

Further, embodiments of the present disclosure provide mechanisms for a (re)association pause recommendation, including: 1. pause recommendation embodiments; 2. pause period recommendation embodiments; 3. indicated APs for pause; 4. request and response based signaling; 5. unsolicited recommendation; 6. un-pause recommendation and behavior; and 7. capability indication.

Further, embodiments of the present disclosure provide mechanisms for link switch suspension, including: 1. unsolicited link switch pause recommendation; 2. pause recommendation upon request; 3. un-pause recommendation; 4. capability indication; and 5. link switch recommendation for the entire network.

Further still, embodiments of the present disclosure provide mechanisms for AP side link reconfiguration parameter setup, including: 1. information exchange for criteria setup; 2. information exchange setup negotiation procedure; 3. unsolicited information transmission procedure; 4. capability indication procedure; 5 example operation.

Further still, embodiments of the present disclosure provide mechanisms for handling a ping pong problem; including: 1. AP-side warning procedures; 2. STA side setup procedure; and 3. capability advertisement.

### A. AP Side Hysteresis Recommendation

### 1. Hysteresis Value Recommendation

Suppose the value of the parameter that the STA uses to perform roam is denoted by c. Suppose that the value of c relative to AP1 is c1 and the value of c relative to AP2 is c2. The STA can perform a roam from AP1 to AP2 when c improves by a value of h. h can be considered as a hysteresis value.

In one example, if the STA uses RSSI as a parameter to evaluate when to roam and RSSI to AP1 is r1 and RSSI for AP2 is r2, the STA can perform a roam when r2>r1+h.

According to one embodiment, the AP can make a hysteresis value recommendation to STA when making the roam. The hysteresis can be for RSSI, load, error rate, etc. The STA can use the hysteresis recommendation when making a roam.

The AP can either recommend a value and the STA can use it or the AP can recommend a range of values and the STA can choose a value out of the range.

### 2. Request and Response Method

According to some embodiments, the STA can make a request to the AP to make a hysteresis recommendation. The STA can transmit a request frame to the AP. The request frame can contain at least one or more of the information items as indicated in Table 1.

TABLE 1
Request frame content

| Information items | Description |
|---|---|
| Vacillation indication | One or more information items that can indicate that the STA |
| | can receive an indication from the AP that it is vacillating |
| | between two APs. |
| Hysteresis | One or more information items that can indicate that the STA is |
| recommendation request | requesting for a hysteresis recommendation from the AP. |
| Roam parameter | One or more information items that can indicate the parameter |
| | that the STA currently uses for roaming. For example, RSSI, |
| | load information, etc. |
| Observation domain | One or more information items that can indicate the observation |
| | domain that the STA prefers. For example, single AP, mobility |
| | domain, entire ESS, etc. |
| Vacillation threshold | One or more information items that can describe the number of |
| | vacillation after which the response can be provided. |

Upon receiving the above request, the AP can provide a hysteresis recommendation/vacillation indication when it observes the STA is vacillating between two APs.

According to some embodiments, the hysteresis recommendation/vacillation indication can be provided by any AP in the mobility domain (mobility domain observation domain). For instance, if the STA makes a request to its current AP (e.g., AP1) and AP2 and AP3 are in the same mobility domain as AP1, then one or more of the other APs can also provide the STA with the hysteresis recommendation/vacillation indication.

According to some embodiments, this setup can apply to only an AP instead of a mobility domain (single AP observation domain). Thus, if the STA has an agreement with one AP, only that AP can provide the hysteresis recommendation/vacillation indication when the STA returns to it. The AP can preserve the agreement even after the STA has disassociated with it.

According to some embodiments, if the setup is performed with an AP, then it can apply to any AP in the same extended service set (ESS). Thus, the hysteresis recommendation/vacillation indication can come from any AP in the same ESS as long as the ESS observes the issue occurring with a STA (ESS observation domain).

According to some embodiments, an AP can transmit a message making the hysteresis recommendation/vacillation indication. The message can contain at least one or more of the information items as indicated in Table 2.

TABLE 2
Hysteresis recommendation/vacillation indication

| Information item | Description |
|---|---|
| Vacillation indication | One or more information items that can indicate to the STA that it |
| | is vacillating between two APs. For example, a bit/flag that can |
| | take a predetermined value (e.g., 1) to make the indication. |
| Hysteresis value/range | One or more information items that can indicate to the STA the |
| | hysteresis value/range. |
| Observation duration | One or more information items that can indicate the period over |
| | which the vacillation was observed. For example, number of |
| | TBTTs of the transmitting AP, etc. |
| Observed APs | One or more information items that can indicate the APs between |
| | which the vacillation was observed. This information can enable |
| | the STA to avoid roaming to these APs. |
| Roam count | One or more information items that can indicate the number of |
| | roams that the STA has performed. |

### 3. Setup During Association

According to some embodiments, the STA can make a request to the AP during association to provide the hysteresis recommendation/vacillation indication. The AP can then provide a report if it/domain/ESS was already making such measurements or can provide these values in the future.

### 4. Unsolicited Indication

According to some embodiments, the AP can transmit an unsolicited recommendation/indication to the STA. The unsolicited recommendation can be provided when the STA associates via a (Re)association response frame or in any independent frame transmitted after association.

### 5. STA Side Behavior

When the STA receives the above recommendation, the STA can use the hysteresis value when determining whether to perform a roam or not. The value can be used only when considering one of the APs from the observed APs set to perform the roam to.

### 6. Capability Indication

According to some embodiments, the AP can advertise one or more of the information items as indicated in Table 3.

TABLE 3
Information items for advertisement

| Information items | Description |
|---|---|
| Vacillation indication | One or more information items that can indicate that the AP can |
| capability | provide a vacillation indication to the STA. |
| Hysteresis | One or more information items that can indicate that the AP can |
| recommendation | provide a hysteresis recommendation to the STA. |

When the STA receives such an advertisement from the AP, the STA can understand that the AP can make such a recommendation, and the STA can trigger a request or expect a response from the AP.

### 7. Example Operation

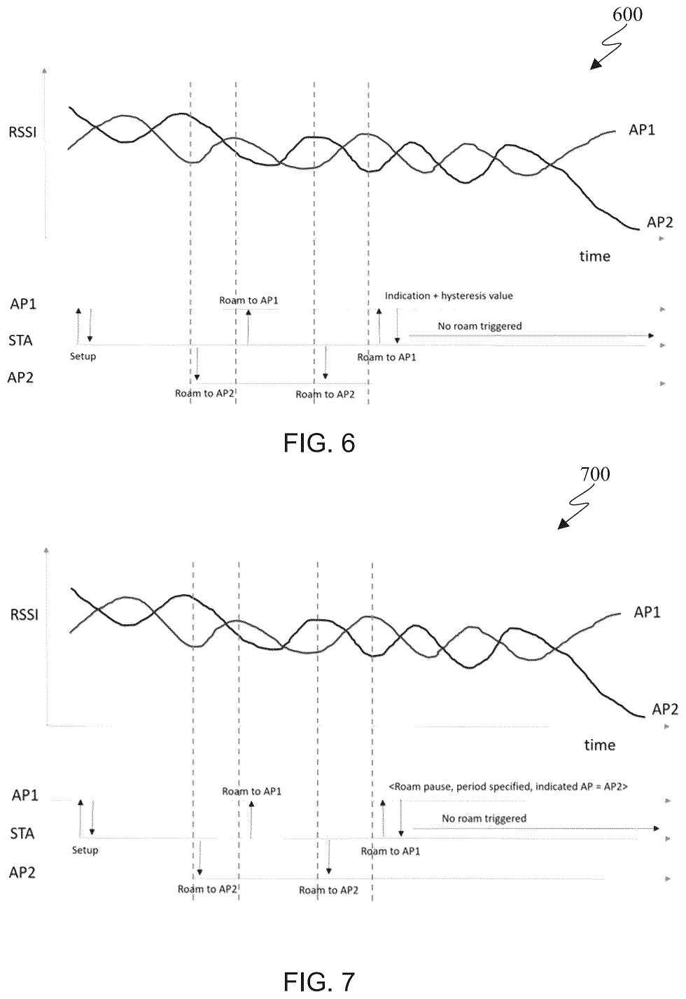

FIG. 6 illustrates an example operation of hysteresis recommendation 600 according to embodiments of the present disclosure. The embodiment of the example operation of hysteresis recommendation 600 shown in FIG. 6 is for illustration only. Other embodiments of the example operation of hysteresis recommendation 600 could be used without departing from the scope of this disclosure.

As illustrated in FIG. 6, initially, the STA may perform some setup with AP1 about getting a hysteresis recommendation, and the AP1 may give the STA a recommendation about a hysteresis value. After a certain number of roams, the AP1 gives the STA an indication that the STA is vacillating between two APs. The AP1 also provides the STA with a hysteresis value, and the STA can use the hysteresis value when determining whether to perform a roam or not. In the example illustrated in FIG. 6, no roam is triggered after the indication and hysteresis value are provided.

The hysteresis value is not limited to being an additive value but can also be other types of values, for example, a multiplicative value. The signaling illustrated in FIG. 6 can be performed on any link setup between the STA and the AP.

### B. (Re)Association Pause Recommendation

### 1. Pause Recommendation

According to some embodiments, the AP can provide a pause recommendation to the STA. The pause recommendation can indicate that the AP recommends that the STA not perform (Re)association for the next specified period of time. The pause can be determined based on a number of criteria such as the AP realizing that the STA is in a region where the vacillation is seen to occur, prior vacillations observed for the given STA, etc.

The AP can also specify a period of time for which the pause can occur. The STA can stop performing roaming during such period of time and maintain connection with its current AP.

When the AP determines that the pause is no longer necessary, the AP can provide an un-pause recommendation to the STA. The un-pause recommendation can indicate to the STA that it can start to perform (Re)association again.

### 2. Pause Period Recommendation

According to some embodiments, the AP can provide a pause period to the STA when making the pause recommendation. The STA can pause its (Re)association for the pause period. After the pause period is over, the STA can start to perform (re)association again. If the STA receives another pause recommendation from the AP, the STA can extend the pause period by the indicated amount.

### 3. Indicated APs

According to some embodiments, the AP can indicate the APs with which the (Re)association can be paused for the above period of time. The STA can trigger roaming to other APs during this period of time.

### 4. Request and Response Based

According to some embodiments, the STA can make a request to the AP to recommend it to pause the (Re)association process. This request can apply either to the single AP in which case only the AP to which the request is made can make such a recommendation in the future.

The request can also apply to a mobility domain in which case any AP in the mobility domain can make the recommendation.

The request can also apply to an ESS in which case, any AP in the ESS can make the recommendation.

The STA can also inform the AP when to stop making such recommendation thereby resulting in a teardown of the setup.

### 5. Unsolicited Recommendation

According to some embodiments, the AP can make an unsolicited recommendation to any STA that can support such a pause procedure.

When the STA receives a recommendation from the AP, the STA can pause its (Re)association to indicated APs for the specified period of time.

### 6. Un-Pause Recommendation and Behavior

The AP can also transmit an un-pause recommendation to the STA in which case the STA reset its pause timer to zero.

If the AP transmits any message to the STA to recommend the STA to roam, then the STA can also reset its pause timer to zero. For example, if the AP transmits a BSS transition management request in which the disassociation imminent bit is set to 1 and/or the abridged bit is set to 1, then the STA can un-pause and start the (Re)association procedure again.

In some embodiments, the STA can also force un-pause. For example, if the STA intends to roam to a different network (e.g., cellular).

### 7. Capability Indication

According to some embodiments, an AP that can provide pause recommendation can advertise its capability, for example, in beacons. This can enable the STA to understand if it can request the AP to provide pause recommendation or expect pause recommendation from the AP in the future.

### 8. Example Operation

FIG. 7 illustrates an example roam pause operation 700 according to embodiments of the present disclosure. The embodiment of the example roam pause operation 700 shown in FIG. 7 is for illustration only. Other embodiments of the example roam pause operation 700 could be used without departing from the scope of this disclosure.

As illustrated in FIG. 7, initially, the STA may perform some setup with AP1 about getting a roam pause recommendation, and the AP1 may give the STA a recommendation about roam pause information. After a certain number of roams, the AP1 gives the STA an indication that the STA is vacillating between two APs. The AP1 also provides the STA with roam pause information, and the STA can use the roam pause information when determining whether to perform a roam or not. In the example illustrated in FIG. 7, no roam is triggered after the indication and roam pause information are provided.

### C. Link Switch Suspension Procedures

### 1. Unsolicited Link Switch Pause Recommendation

According to some embodiments, the AP can make a link switch pause recommendation to the STA. The AP can transmit the recommendation in a message to the STA and the message can contain at least one or more of the information items as indicated in Table 4.

TABLE 4
Information items in the link switch pause recommendation message

| Information | |
|---|---|
| items | Description |
| Link switch pause | One or more information item(s) that can indicate that the AP requests |
| recommendation | the STA to pause its link switch operation. |
| Pause period | One or more information item(s) that can indicate the duration for |
| | which the link switch operation can be paused. After the period is |
| | elapses, then the STA can start making the request again. |
| Paused link | One or more information item(s) that can indicate the link(s) for which |
| | the switching has been paused. For example, specific links of APs |
| | between which the STA has been switching very frequently. |
| Un-paused link | One or more information item(s) that can indicate the link(s) for which |
| | the switching has not been paused. The STA can still switch to these |
| | links. |
| Reason | One or more information item(s) that can indicate the reason for making |
| information | the pause recommendation. For example, reason code. |
| Reference | One or more information item(s) that can serve as a reference |
| information | information for the pause recommendation. For example, dialog token. |
| | The same dialog token can be used when making the unpause |
| | recommendation. |

The above recommendation can be made by the AP in which case the STA can have a link setup with the AP.

The above recommendation can be made by the logical entity in which case the recommendation can come from any AP in the domain.

The pause recommendation can be cumulative over time. For instance, if the AP/logical entity transmits a pause recommendation pausing switching to link 1 and at a later point in time transmits another pause recommendation that recommends to pause switching to link 2, the STA can add the second pause recommendation to the first one thereby pausing switch operation to link 1 and 2.

The pause recommendations can also overwrite prior pause operation. For example, if the AP/logical entity transmits a pause recommendation to pause switch to link 1 and at a later point in time transmits a pause recommendation to pause switch to link 2, then the second pause recommendation can overwrite the first one and STA can suspend pause switch operation to link 2 only.

### 2. Pause Recommendation Upon Request

According to one embodiment, the pause request can be made upon request by the STA. For example, during association the STA can indicate to the AP that it can receive the pause recommendation and AP/logical entity can send the pause recommendation when necessary.

The STA can also send a pause recommendation request to the AP/logical entity after association.

### 3. Un-Pause Recommendation

According to one embodiment, the AP/logical entity can also send an un-pause recommendation. The un-pause recommendation can cause the STA to resume the link switch operation again. If the pause recommendation caused the STA to pause link switch to specific set of links, then the un-pause recommendation can carry the same dialog token as the pause links to indicate the pause recommendation that it can correspond to. The un-pause recommendation can also be used to modify any prior pause recommendations.

The pause and un-pause recommendation may come from an AP that is different from the AP with which the setup was performed. For example, the STA can perform a request response setup to request pause recommendation from AP1 and at a later point in time form links with another AP (e.g., AP2). In this case, if AP1 and AP2 are a part of the same domain and are connected via the logical entity, then AP2 can also make the un-pause recommendation.

### 4. Capability Indication

An AP that can provide pause and un-pause recommendations to the STA can advertise its capability in one or more frames that it transmits, for example, beacon frames. There can be a capability bit that can be set to 1 to make the indication and to 0 to indicate otherwise. STAs that receive the indication can understand that they can request/receive pause/un-pause recommendations from the AP.

### 5. Link Switch Suspension on the Entire Network

According to some embodiments, the AP/logical entity can suspend link switch operation on the entire network. For example, there can be a suspension bit in the beacon that can be set to 1 to make the indication. When STAs receive such an indication, they can stop making link switch requests for a set period of time.

### D. Ap Side Link Reconfiguration Parameter Setup

### 1. Information Exchange for Criteria Setup

According to some embodiments, the AP can provide a recommendation on which parameters to use when making a link switch. Examples of these parameters can be as follows.
1. Received signal strength.
2. Total load on the AP.
3. Load on the AP for the ACs/TIDs that correspond to the application that the STA is running.
4. Number of STAs associated with the AP, etc.

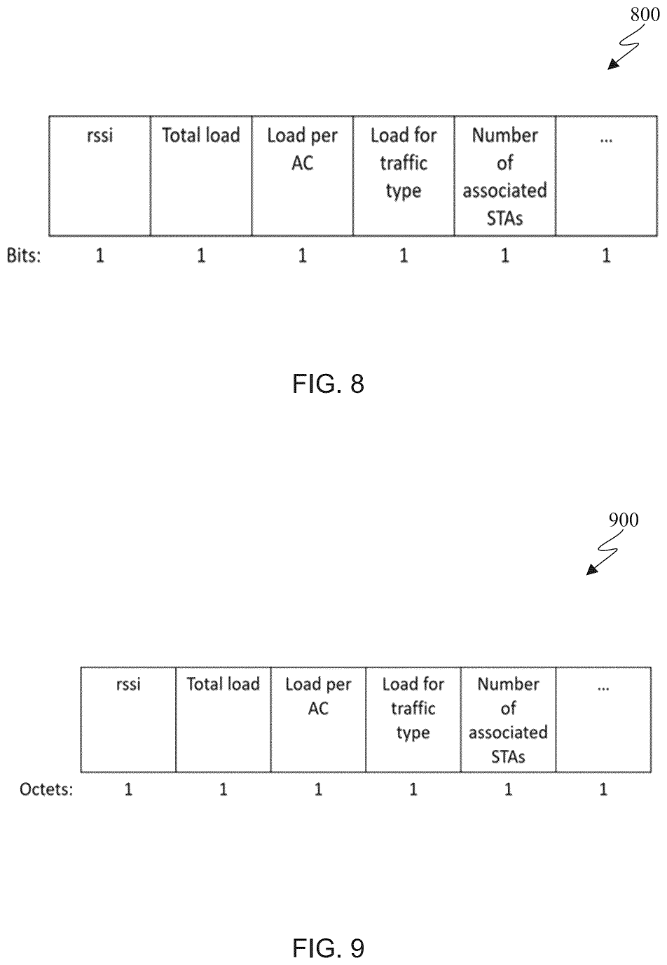

FIG. 8 illustrates an example of a message 800 that can contain an indication of criteria that the STA can use according to embodiments of the present disclosure. The embodiment of the example message 800 that can contain an indication of criteria that the STA can use shown in FIG. 8 is for illustration only. Other embodiments of the example message 800 that can contain an indication of criteria that the STA can use could be used without departing from the scope of this disclosure.

The AP can transmit a message to the STA that can contain an indication of which criteria the STA can use. In some embodiments, the AP can make a recommendation of the criteria to use when performing a switch. An example signaling can be as shown in FIG. 8.

As illustrated in FIG. 8, a bitmap can be used to indicate what parameters to use for making a link switch. For example, when the bit corresponding to the RSSI field is set to 1, it can indicate that RSSI can be used as one of the parameters to determine when to make the switch. When the field is set to a value of 0, it can indicate that the AP does not recommend to use RSSI as one of the parameters to determine when to make the switch. The same description can apply to each of the other fields, which may include total load, load per AC, load for traffic type, and number of associated STAs. Other parameters can be used.

FIG. 9 illustrates an example of a message 900 for threshold indication according to embodiments of the present disclosure. The embodiment of the example message 900 for threshold indication shown in FIG. 9 is for illustration only. Other embodiments of the example message 900 for threshold indication could be used without departing from the scope of this disclosure.

According to some embodiments, the AP can also make a recommendation on what should be a good threshold for a particular parameter when making the switch. An example signaling can be as shown in FIG. 9

As illustrated in FIG. 9, the RSSI field can take the value that can be used as a threshold for RSSI when determining when to make a switch. If RSSI degrades below this recommended value, the STA can attempt a link switch. The same description can also apply to other fields, which may include total load, load per AC, load for traffic type, and number of associated STAs. Other parameters can be used.

According to some embodiments, the AP can also recommend an improvement value to the STA. The STA can use the value and make a switch only when the parameter that the STA is using improves by the recommended value. For instance, the AP can recommend a value of 3 dB for RSSI. The STA can make a switch only when RSSI on the new link improves by 3 dB. Example signaling can be similar to as shown in FIG. 9.

### 2. Information Exchange Setup Negotiation

According to some embodiments, the STA can make a request to the AP to provide the STA with a recommendation. The request message can contain at least one or more of the information items as shown in Table 5.

TABLE 5
Information items that can be present in the request message

| Information items | Description |
|---|---|
| Reason information | One or more information item(s) that can describe a reason |
| | information for making the request. For example, a reason code. |
| Parameter | One or more information item(s) that can indicate that the STA is |
| recommendation | requesting the AP to make a recommendation of what parameters to |
| | use for link switch. For example, a bit/flag that can be set to 1 to |
| | make the indication. |
| Parameter threshold | One or more information item(s) that can indicate that the STA is |
| recommendation | requesting the AP to make a recommendation of what threshold to |
| | use for the parameters for link switch. For example, a bit/flag that |
| | can be set to 1 to make the indication. |
| Parameter | One or more information item(s) that can indicate that the STA is |
| improvement value | requesting the AP to make recommendation of the parameter |
| recommendation | improvement value. For example, a bit/flag that can be set to 1 to |
| | make the indication. |

Upon receiving the above request, the AP can accept or reject the request. If the AP accepts the request, the AP can make a recommendation to the STA. The recommendation message can contain at least one or more of the information items as shown in Table 6.

TABLE 6
Information items that can be present in the recommendation message

| Information items | Description |
|---|---|
| Parameter | One or more information item(s) that can describe the parameters that |
| recommendation | the AP can recommend for making a link switch. For example, the |
| | signaling depicted in FIG. 8. |
| Parameter threshold | One or more information item(s) that can describe the threshold that |
| recommendation | the STA can use for making a link switch. For example, the signaling |
| | depicted in FIG. 9. |
| Parameter | One or more information item(s) that can describe the value that the |
| improvement value | STA can use for making a link switch. For example, the signaling |
| recommendation | depicted in FIG. 9 with the fields carrying the value for the |
| | recommended improvement values. |

When the STA receives the above recommendation, the STA can use the recommended parameters, their thresholds and their improvement values when making a link switch.

### 3. Unsolicited Information Transmission

The AP can also make the recommendation in an unsolicited manner without the request from the STA. For instance, if the AP observes that the STA may not be switching to better links after link switch, the AP can send an unsolicited recommendation.

### 4. Capability Indication

An AP that can provide such a recommendation can advertise its capability in one or more frames that it transmits. For example, management frames in a beacon frame. The signaling can involve a capability bit that can be set to 1 to make the indication. When a STA receives the above bit with a value set to 1, the STA can understand that it can request/receive recommendations from the AP.

### 5. Example Operation

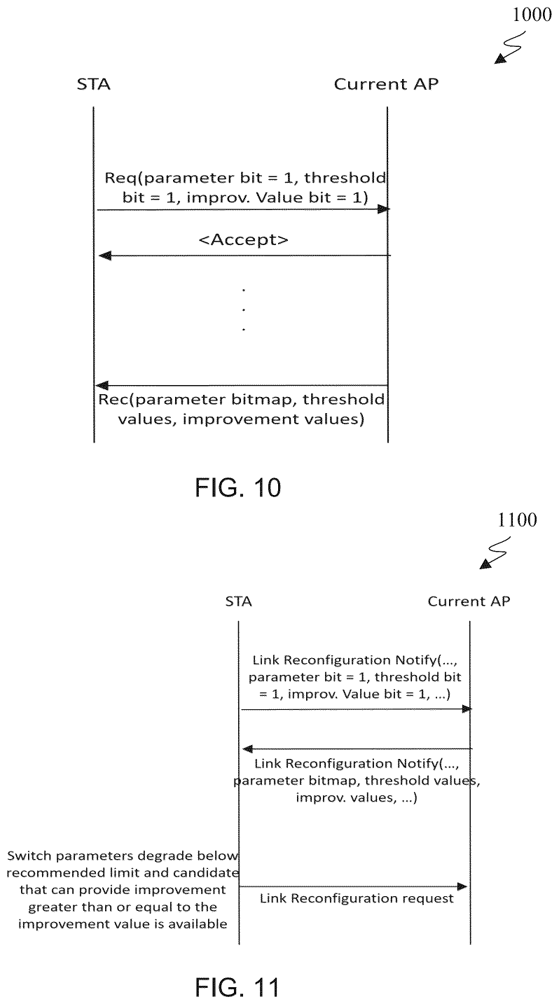

FIG. 10 illustrates an example operation 1000 of a capability indication according to embodiments of the present disclosure. The embodiment of the example operation 1000 of a capability indication shown in FIG. 10 is for illustration only. Other embodiments of the example operation 1000 of a capability indication could be used without departing from the scope of this disclosure.

As illustrated in FIG. 10, the STA can make a request to the AP to provide the STA with a recommendation of what parameters to use for link switch, what threshold to use for the parameters for link switch, and of the parameter improvement value. After receiving the request, the AP can send an accept or reject message to the STA, and if the AP accepts the request, the AP can make a recommendation to the STA.

FIG. 11 illustrates an example operation by embedding signaling in a link switch procedure 1100 according to embodiments of the present disclosure. The embodiment of the example operation by embedding signaling in a link switch procedure 1100 shown in FIG. 11 is for illustration only. Other embodiments of the example operation by embedding signaling in a link switch procedure 1100 could be used without departing from the scope of this disclosure.

As illustrated in FIG. 11, the signaling can also be embedded in one or more of the link switch procedures, such as the link reconfiguration procedure.

### E. Ping Pong Warning

### 1. AP-Side Warning

According to some embodiments, the AP can issue a ping pong warning to the STA. The AP can determine if the STA is likely to face a ping pong problem and provide a warning to it.

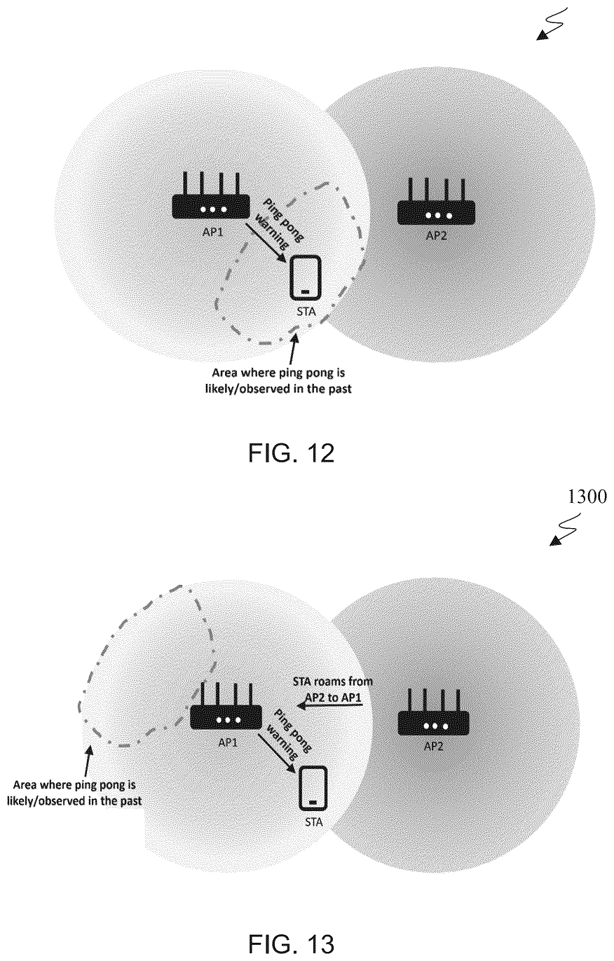

FIG. 12 illustrates an example operation 1200 indicating that ping pongs have occurred in the past between AP1 and AP2 according to embodiments of the present disclosure. The embodiment of the example operation 1200 indicating that ping pongs have occurred in the past between AP1 and AP2 shown in FIG. 12 is for illustration only. Other embodiments of the example operation 1200 indicating that ping pongs have occurred in the past between AP1 and AP2 could be used without departing from the scope of this disclosure.

FIG. 13 illustrates another example operation 1300 indicating that ping pongs have occurred in the past between AP1 and AP2 according to embodiments of the present disclosure. The embodiment of the example operation 1300 indicating that ping pongs have occurred in the past between AP1 and AP2 shown in FIG. 13 is for illustration only. Other embodiments of the example operation 1300 indicating that ping pongs have occurred in the past between AP1 and AP2 could be used without departing from the scope of this disclosure.

In one example as illustrated in FIG. 12, the AP can keep a record of prior ping pongs in a particular area. If the STA is in that area, the AP can issue a warning to it. In one example as illustrated in FIG. 13, the AP can issue a warning to the STA about the possibility of encountering a ping pong problem in the future. The warning message transmitted to the STA can include at least one or more of the information items as indicated in Table 7.

TABLE 7
Information items that can be present in the warning message

| Information items | Description |
|---|---|
| Ping pong possibility | One or more information item(s) that can warn that the STA can |
| indication | encounter a ping pong issue. For example, a bit/flag that can take a |
| | predetermined value to make the indication. |
| RSSI hysteresis | One or more information item(s) that can indicate the RSSI hysteresis |
| | that the STA can use when it encounters a ping pong problem. |
| Pattern for ping pong | One or more information item(s) that can indicate the pattern for |
| | identifying ping pong. For example, AP groups/pairs between |
| | which ping pong occurs indicated via their BSSID. |
| Recommended action | One or more information item(s) that can indicate the recommended |
| | action that the STA can take. For example, suspend roam for a |
| | certain number of TBTTs, suspend roam until RSSI has degraded |
| | below a certain threshold, etc. |
| Warning reason | One or more information item(s) that can indicate if the warning is |
| | being issued due to the STA being in a ping pong area or to warn the |
| | STA or its possibility in the future. For example, via a reason code. |

When a STA receives the above warning, it can use it to prevent ping pongs.

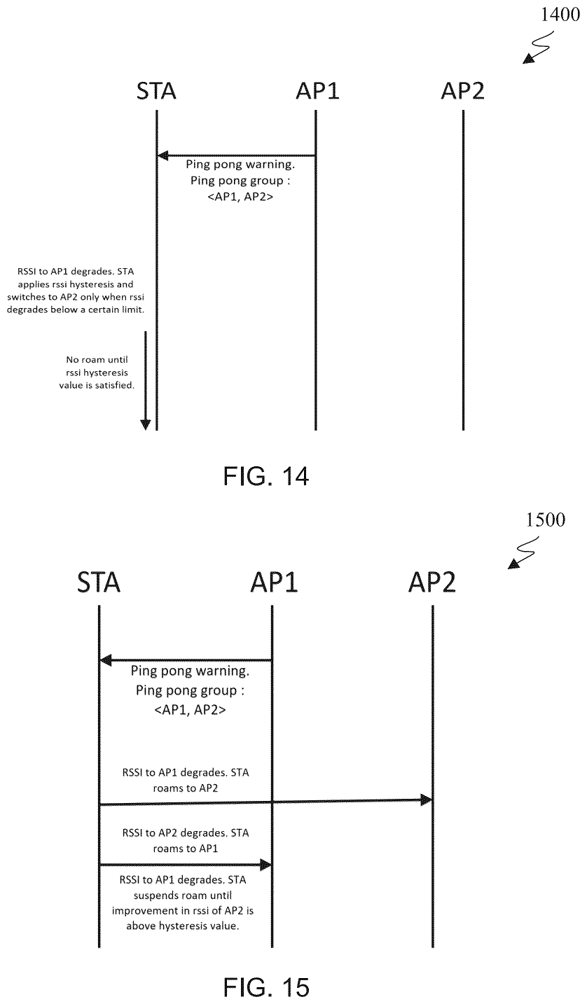

FIG. 14 illustrates an example operation 1400 for a ping pong warning message according to embodiments of the present disclosure. The embodiment of the example operation 1400 for a ping pong warning message shown in FIG. 14 is for illustration only. Other embodiments of the example operation 1400 for a ping pong warning message could be used without departing from the scope of this disclosure.

As illustrated in FIG. 14, a STA receives the above warning message from AP1 indicating that ping pongs have occurred in the past between AP1 and AP2. When the STA observes a roam being triggered from AP1 to AP2, the STA can use the RSSI hysteresis and avert a ping pong.

FIG. 15 illustrates another example operation 1500 for a ping pong warning message according to embodiments of the present disclosure. The embodiment of the example operation 1500 for a ping pong warning message shown in FIG. 15 is for illustration only. Other embodiments of the example operation 1500 for a ping pong warning message could be used without departing from the scope of this disclosure.

As illustrated in FIG. 15, a STA receives the above warning message from AP1 indicating that ping pongs have occurred in the past between AP1 and AP2. When the STA observes a few roams between the two APs, the STA can use the RSSI hysteresis and stop the ping pong early on. The above warning message can enable the STA to stop ping pong in an early stage or avert it altogether.

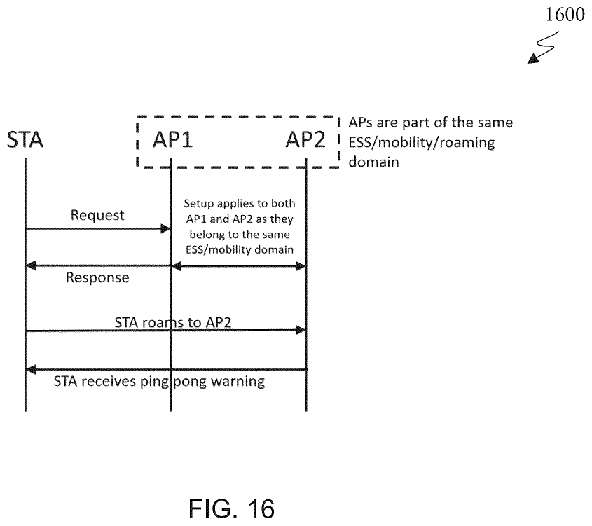

FIG. 16 illustrates an example operation 1600 for setup of a ping pong warning message according to embodiments of the present disclosure. The embodiment of the example operation 1600 for setup of a ping pong warning message shown in FIG. 16 is for illustration only. Other embodiments of the example operation 1600 for setup of a ping pong warning message could be used without departing from the scope of this disclosure.

### 2. Setup for Ping Pong

According to some embodiments, the STA can request a ping pong warning message. The STA can request the warning message from an AP but it can apply to any APs in the same ESS.

As illustrated in FIG. 16, the STA can send a request message to one of the APs in the ESS and make a request to be provided with a ping pong warning message. If the AP accepts, the request can apply to all the APs in the ESS. At a later point, if the STA roams to a different AP whose STAs have faced ping pong in the past, the AP can provide a warning to the STA and the STA can use the warning and the indicated configuration (RSSI hysteresis, recommended action, etc.).

### 3. Capability Indication

An AP that can provide a ping pong indication can advertise the capability in one or more frames that it transmits. For example, the capability can be advertised via a capability bit that can be set to 1 when the AP supports the capability and to 0 when the AP does not.

A STA that can receive a ping pong warning can advertise the capability in one or more frames that it transmits. For example, the capability can be advertised via a capability bit that can be set to 1 when the STA can support warning message handling and to 0 when it cannot.

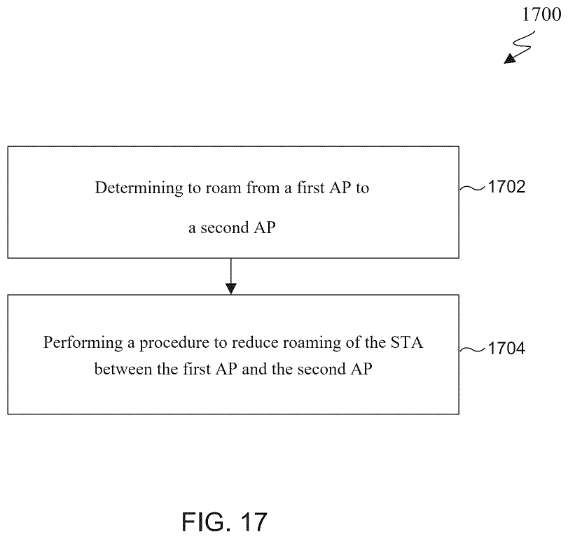

FIG. 17 illustrates an example method 1700 performed by a STA in a wireless communication system according to embodiments of the present disclosure. The method 1700 of FIG. 17 can be performed by any of the STAs 111-114 of FIG. 1, such as the STA 111 of FIG. 3. The method 1700 is for illustration only and other embodiments can be used without departing from the scope of the present disclosure.

As illustrated in FIG. 17, the method 1700 begins at step 1702, where the STA determines to roam from a first AP to a second AP. At step 1704, the STA performs a procedure to reduce roaming of the STA between the first AP and the second AP.

In some embodiments, the procedure to reduce roaming comprises a hysteresis procedure. The hysteresis procedure comprises: receiving a hysteresis recommendation associated with a value of a parameter that the STA uses to perform roaming; and determining that the value of the parameter that the STA uses to perform roaming satisfies a threshold value prior to roaming between the first AP and the second AP.

In some embodiments, the hysteresis procedure further comprises: receiving an indication that the STA is vacillating between the first AP and the second AP; and using the hysteresis recommendation and the indication that the STA is vacillating between the first AP and the second AP when making a roam.

In some embodiments, the procedure to reduce roaming comprises a pause procedure. The pause procedure comprises: receiving a pause recommendation indicating to the STA not to perform an association operation for a period of time; and determining not to perform the association operation for the period of time based on the pause recommendation.

In some embodiments, the procedure to reduce roaming comprises a link switch suspension procedure. The link switch suspension procedure comprises: receiving a link switch pause recommendation indicating to the STA not to perform a link switch operation for a period of time; and determining not to perform the link switch operation for the period of time based on the link switch pause recommendation.

In some embodiments, the procedure to reduce roaming comprises a link reconfiguration procedure. The link reconfiguration procedure comprises: receiving a link reconfiguration recommendation indicating to the STA which parameters to use when making a link switch.

In some embodiments, the procedure to reduce roaming comprises a ping-pong roaming procedure. The ping-pong roaming procedure comprises: receiving a ping-pong warning indicating to the STA a likelihood of encountering a ping-pong issue, wherein the ping-pong issue comprises the STA vacillating between the first AP and the second AP; and determining not to roam between the first AP and the second AP based on the ping-pong warning.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a station (STA), the method comprising:
determining to roam from a first access point (AP) to a second AP; and
performing a procedure to reduce roaming of the STA between the first AP and the second AP.

2. The method of claim 1, wherein the procedure to reduce roaming comprises a hysteresis procedure, the hysteresis procedure comprising:
receiving a hysteresis recommendation associated with a value of a parameter that the STA uses to perform roaming; and
determining that the value of the parameter that the STA uses to perform roaming satisfies a threshold value prior to roaming between the first AP and the second AP.

3. The method of claim 2, wherein the hysteresis procedure further comprises:
receiving an indication that the STA is vacillating between the first AP and the second AP; and
using the hysteresis recommendation and the indication that the STA is vacillating between the first AP and the second AP when making a roam.

4. The method of claim 1, wherein the procedure to reduce roaming comprises a pause procedure, the pause procedure comprising:
receiving a pause recommendation indicating to the STA not to perform an association operation for a period of time; and
determining not to perform the association operation for the period of time based on the pause recommendation.

5. The method of claim 1, wherein the procedure to reduce roaming comprises a link switch suspension procedure, the link switch suspension procedure comprising:
receiving a link switch pause recommendation indicating to the STA not to perform a link switch operation for a period of time; and
determining not to perform the link switch operation for the period of time based on the link switch pause recommendation.

6. The method of claim 1, wherein the procedure to reduce roaming comprises a link reconfiguration procedure, the link reconfiguration procedure comprising:
receiving a link reconfiguration recommendation indicating to the STA which parameters to use when making a link switch.

7. The method of claim 1, wherein the procedure to reduce roaming comprises a ping-pong roaming procedure, the ping-pong roaming procedure comprising:
receiving a ping-pong warning indicating to the STA a likelihood of encountering a ping-pong issue, wherein the ping-pong issue comprises the STA vacillating between the first AP and the second AP; and
determining not to roam between the first AP and the second AP based on the ping-pong warning.

8. A first access point (AP) comprising:
a transceiver; and
a processor operably coupled with the transceiver, the processor configured to:
generate a message associated with a station (STA) that has determined to roam from the first AP to a second AP, the message including information associated with a procedure to reduce roaming of the STA between the first AP and the second AP; and
transmit, via the transceiver, the message to the STA.

9. The first AP of claim 8, wherein:
the information related to the procedure to reduce roaming of the STA between the first AP and the second AP comprises a hysteresis procedure; and
to generate the message, the processor is further configured to:
generate a hysteresis recommendation associated with a value of a parameter that the STA uses to perform roaming.

10. The first AP of claim 8, wherein:
the information related to the procedure to reduce roaming of the STA between the first AP and the second AP comprises a pause procedure; and
to generate the message, the processor is further configured to:
generate a pause recommendation indicating to the STA not to perform an association operation for a period of time.

11. The first AP of claim 8, wherein:
the information related to the procedure to reduce roaming of the STA between the first AP and the second AP comprises a link switch suspension procedure; and
to generate the message, the processor is further configured to:
generate a link switch pause recommendation indicating to the STA not to perform a link switch operation for a period of time.

12. The first AP of claim 8, wherein:
the information related to the procedure to reduce roaming of the STA between the first AP and the second AP comprises a link reconfiguration procedure; and
to generate the message, the processor is further configured to:
generate a link reconfiguration recommendation indicating to the STA which parameters to use when making a link switch.

13. The first AP of claim 8, wherein:
the information related to the procedure to reduce roaming of the STA between the first AP and the second AP comprises a ping-pong roaming procedure; and
to generate the message, the processor is further configured to:
generate a ping-pong warning indicating to the STA a likelihood of encountering a ping-pong issue, wherein the ping-pong issue comprises the STA vacillating between the first AP and the second AP.

14. A station (STA), comprising:
a transceiver; and
a processor operably coupled with the transceiver, the processor configured to:
determine to roam from a first access point (AP) to a second AP; and
perform a procedure to reduce roaming of the STA between the first AP and the second AP.

15. The STA of claim 14, wherein:
the procedure to reduce roaming comprises a hysteresis procedure; and
to perform the hysteresis procedure, the processor is further configured to:
receive, from the second AP, a hysteresis recommendation associated with a value of a parameter that the STA uses to perform roaming; and
determine that the value of the parameter that the STA uses to perform roaming satisfies a threshold value prior to roaming between the first AP and the second AP.

16. The STA of claim 15, wherein to perform the hysteresis procedure, the processor is further configured to:
receive an indication that the STA is vacillating between the first AP and the second AP; and
use the hysteresis recommendation and the indication that the STA is vacillating between the first AP and the second AP when making a roam.

17. The STA of claim 14, wherein:
the procedure to reduce roaming comprises a pause procedure; and
to perform the pause procedure, the processor is further configured to:
receive a pause recommendation indicating to the STA not to perform an association operation for a period of time; and
determine not to perform the association operation for the period of time based on the pause recommendation.

18. The STA of claim 14, wherein:
the procedure to reduce roaming comprises a link switch suspension procedure; and
to perform the link switch suspension procedure, the processor is further configured to:
receive a link switch pause recommendation indicating to the STA not to perform a link switch operation for a period of time; and
determine not to perform the link switch operation for the period of time based on the link switch pause recommendation.

19. The STA of claim 14, wherein:
the procedure to reduce roaming comprises a link reconfiguration procedure; and
to perform the link reconfiguration procedure, the processor is further configured to:
receive a link reconfiguration recommendation indicating to the STA which parameters to use when making a link switch.

20. The STA of claim 14, wherein:
the procedure to reduce roaming comprises a ping-pong roaming procedure; and
to perform the ping-pong roaming procedure, the processor is further configured to:
receive a ping-pong warning indicating to the STA a likelihood of encountering a ping-pong issue, wherein the ping-pong issue comprises the STA vacillating between the first AP and the second AP; and
determine not to roam between the first AP and the second AP based on the ping-pong warning.
